(19) United States
(12) Patent Application Publication
(10) Pub. No.: US 2014/0035841 A1
(43) Pub. Date: Feb. 6, 2014

(54) SENSOR FOR DIGITIZER AND METHOD FOR MANUFACTURING THE SAME

(71) Applicant: SAMSUNG ELECTRO-MECHANICS CO., LTD., Suwon (KR)

(72) Inventors: Dong Sik Yoo, Suwon (KR); Kyoung Soo Chae, Suwon (KR); Ho Yun Cho, Suwon (KR); Yun Ki Hong, Suwon (KR); Hee Bum Lee, Suwon (KR)

(73) Assignee: SAMSUNG ELECTRO-MECHANICS CO., LTD., Suwon (KR)

(21) Appl. No.: 13/727,423

(22) Filed: Dec. 26, 2012

(30) Foreign Application Priority Data
Aug. 3, 2012 (KR) 10-2012-0085272

(51) Int. Cl. G06F 3/041; H01F 41/02

(52) U.S. Cl. CPC G06F 3/041; H01F 41/02
USPC 345/173; 29/607; 178/18.03

(57) ABSTRACT

Disclosed herein are a sensor for a digitizer and a method for manufacturing the same. The sensor for a digitizer includes a magnetic layer having insulation property, a first coil formed on one surface of the magnetic layer, an insulating layer formed on one surface of the magnetic layer while covering the first coil, and a second coil formed on one surface of the insulating layer. By this configuration, the coil is directly formed on the magnetic layer to simplify a structure and improve stability of a signal transmitted and received from and to a coil by the magnetic layer.

### CROSS REFERENCE TO RELATED APPLICATION

This application claims the benefit of Korean Patent Application No. 10-2012-0085272, filed on Aug. 3, 2012, entitled “Sensor For Digitizer And Method For Manufacturing The Same”, which is hereby incorporated by reference in its entirety into this application.

### BACKGROUND OF THE INVENTION

1. Technical Field

The present invention relates to a sensor for a digitizer and a method for manufacturing the same.

2. Description of the Related Art

In accordance with the growth of computers using a digital technology, devices assisting computers have also been developed, and personal computers, portable transmitters and other personal information processors execute processing of text and graphics using a variety of input devices such as a keyboard and a mouse.

While the rapid advancement of an information-oriented society has widened the use of computers more and more, it is difficult to efficiently operate products using only a keyboard and a mouse currently serving as an input device. Therefore, the necessity for a device that is simple, has minimum malfunction, and is capable of easily inputting information has increased.

In addition, current techniques for input devices have progressed toward techniques related to high reliability, durability, innovation, designing and processing beyond the level of satisfying general functions. To this end, an electromagnetic induction type digitizer has been developed as an input device capable of inputting information such as text, graphics, or the like.

An example of an input device capable of performing a function similar to the electromagnetic induction type digitizer may include a capacitive type touch screen. However, the capacitive type touch screen cannot accurately sense coordinates and cannot also recognize writing pressure, as compared to the electromagnetic induction type digitizer. Therefore, the electromagnetic induction type digitizer has more excellent precision or accuracy than the capacitive type touch screen.

An example of the digitizer according to the prior may include a digitizer disclosed in Korean Patent No. 10-0510729 as the prior art.

The digitizer disclosed in Korean Patent No. 10-0510729 is configured to include a sensor disposed under a liquid crystal panel and transmitting and receiving electromagnetic waves resonated at a location at which an electronic pen is touched to recognize the touched location and a controller controlling the sensor.

Here, the sensor is configured to include a sensor PCB and a plurality of X-axis coils and Y-axis coils formed on the sensor PCB.

In addition, the controller is a control processor unit (CPU) that is disposed under the sensor to transmit a signal to the sensor and read an input signal again to sense a location of an electronic pen.

Moreover, the electronic pen includes a resonance circuit configured of a coil and a capacitor formed therein.

The digitizer according to the prior art is operated by allowing the sensor to receive a signal from the controller and generates electromagnetic waves while inducing electromagnetism by selecting the X-axis and Y-axis coils. The electronic pen is resonated by the generated electromagnetic waves and a resonance frequency is received by the sensor while being held for a predetermined time. The controller reads the signal received by the sensor to sense the touched location.

Meanwhile, the digitizer needs to have more improved stability of a signal, such as preventing the signal transmitted and received from and to the coil from being attenuated due to the influence of peripheral devices, and the like. However, the digitizer according to the prior art does not include separate components meeting the requirements.

### SUMMARY OF THE INVENTION

The present invention has been made in an effort to provide a sensor for a digitizer with improved stability of a signal transmitted and received from and to a sensor and a method for manufacturing the same.

According to a preferred embodiment of the present invention, there is provided a sensor for a digitizer, including: a magnetic layer having insulation property; a first coil formed on one surface of the magnetic layer; an insulating layer formed on one surface of the magnetic layer while covering the first coil; and a second coil formed on one surface of the insulating layer.

The sensor for a digitizer may further include: a power coil formed on one surface of the insulating layer.

The power coil may be formed on an outer side of the insulating layer.

The magnetic layer may be formed by curing a mixture of a magnetic powder and a binder.

The magnetic powder may include an alloy powder of Fe—Si—Al.

The binder may include acrylonitrile-butadience-styrene (ABS).

An upper layer portion of the magnetic layer may have the mixture ratio of the binder relatively higher than that of a lower layer portion of the magnetic layer.

According to another preferred embodiment of the present invention, there is provided a method for manufacturing a sensor for a digitizer, including: (a) forming a magnetic layer on one surface of a base film; (b) forming a first coil on one surface of the magnetic layer; (c) forming an insulating layer on one surface of the magnetic layer so as to cover the first coil; and (d) forming a second coil on one surface of the insulating layer.

The method for manufacturing a sensor for a digitizer may further include: after the step (a), peeling off the base film from the magnetic layer.

The method for manufacturing a sensor for a digitizer may further include: after the step (d), forming a power coil on one surface of the insulating layer.

The power coil may be formed on an outer side of the insulating layer.

In the step (a), the magnetic layer may be formed by applying and curing a mixture of a magnetic powder and a binder to the base film.

The magnetic powder may include an alloy powder of Fe—Si—Al.

The binder may include acrylonitrile-butadience-styrene (ABS).

In the step (a), the magnetic layer may be formed by sequentially applying and curing a first mixture and a second mixture in which the magnetic powder and the binder are mixed to the base film, the second mixture having a mixing ratio of the binder relatively higher than that of the first mixture.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a sensor for a digitizer according to a preferred embodiment of the present invention;

FIG. 2 is a perspective view of main components so as to understand a shape of a first coil and a second coil shown in FIG. 1; and

FIGS. 3 to 7 are cross-sectional views for describing a method for manufacturing the sensor for a digitizer shown in FIG. 1.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

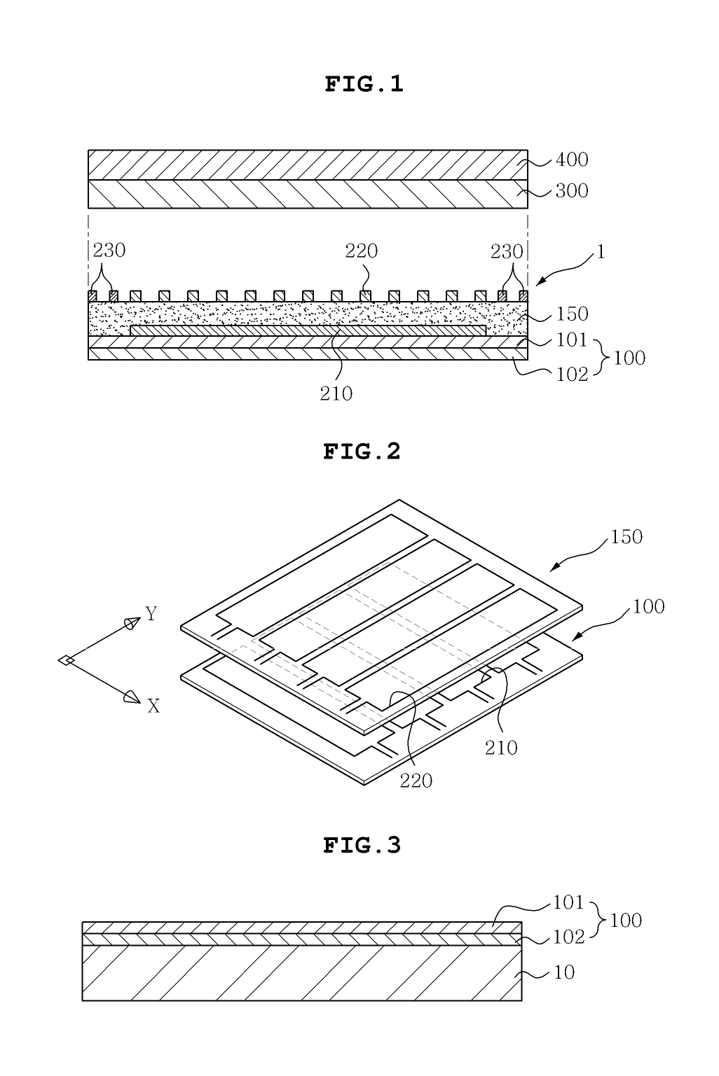

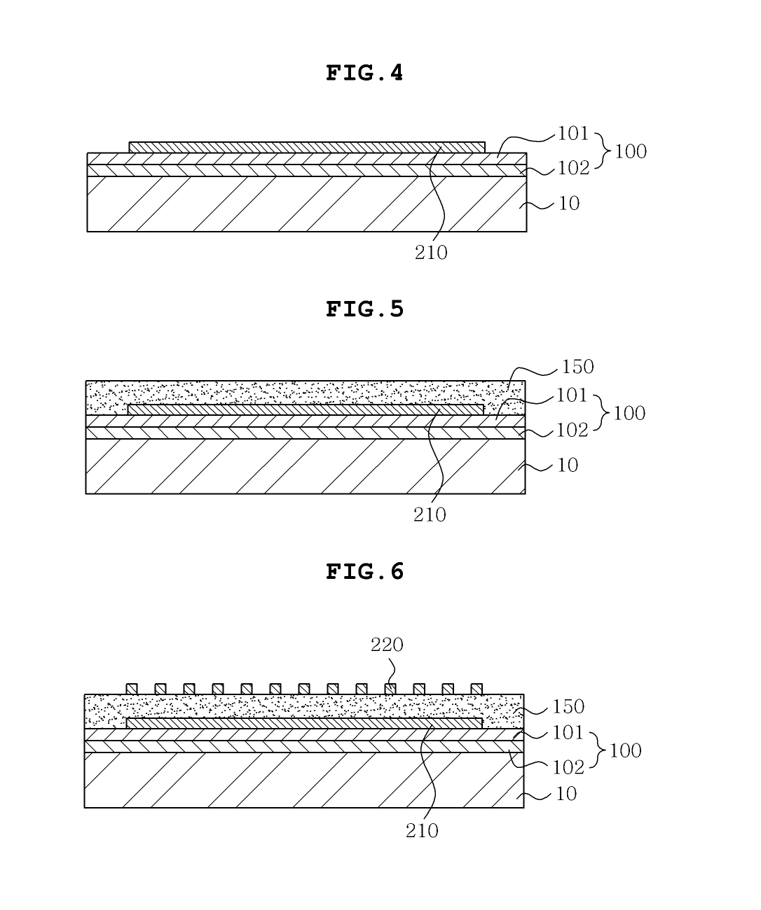

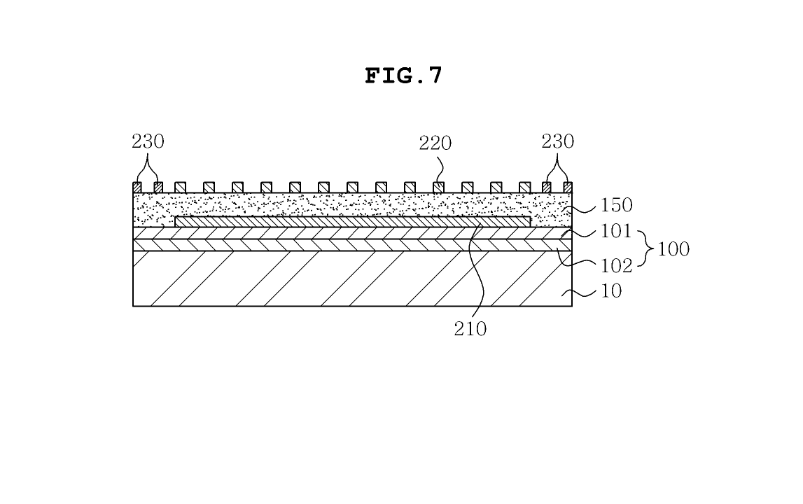

FIG. 1 is a cross-sectional view of a sensor for a digitizer according to a preferred embodiment of the present invention, FIG. 2 is a perspective view of main components so as to understand a shape of a first coil and a second coil shown in FIG. 1, and FIGS. 3 to 7 are cross-sectional views for describing a method for manufacturing the sensor for a digitizer shown in FIG. 1.

As shown in FIG. 1, a sensor 1 for a digitizer according to a preferred embodiment of the present invention is configured to include a magnetic layer 100 having insulation property, a first coil 210 formed on one surface of the magnetic layer 100, an insulating layer 150 formed on one surface of the magnetic layer 100 while covering the first coil 210, and a second coil 220 formed on one surface of the insulating layer 150.

The magnetic layer 100 serves to improve stability of a signal transmitted and received between a resonance circuit and a coil of an input device (not shown) such as an electronic pen. In detail, as a portable terminal such as a tablet, and the like, is miniaturized, various types of conductors are disposed around a sensor for a digitizer. In this case, magnetic field generated from the coil transmitting and receiving a signal included in the sensor for a digitizer is largely attenuated or a resonance frequency is shifted, due to the presence of the conductors, such that the transmission and reception of a signal may be instable. Therefore, according to the preferred embodiment of the present invention, the coil is formed on the magnetic layer 100 to prevent electromagnetic inductive obstruction due to the conductors disposed under the magnetic layer 100, thereby making it possible to improve the stability of a signal transmitted and received between the resonance circuit and the coil of the input device.

The magnetic layer 100 may also have electric insulation property so as to insulate between lines of the first coil 210 to be described below.

In detail, a mixture of a magnetic powder and a binder may be cured so as to form the magnetic layer 100.

In this case, the magnetic powder may be formed of, for example, an alloy powder of Fe—Si—Al and may also be formed of variously known materials having magnetism. Further, the binder may be formed of, for example, acrylonitrile-butadience-styrene(ABS) and may also be formed of various materials so that the magnetic layer has insulation property.

The magnetic layer 100 may have insulation property by appropriately controlling a mixing ratio of the magnetic powder and the binder. In this case, when a relative mixing ratio of the binder to the magnetic powder is too low, the magnetic layer 100 may not have sufficient magnetism and when a relative mixing ratio of the magnetic powder to the binder is too low, the magnetic layer 100 may not have sufficient insulation property. Therefore, it is preferable to appropriately control the mixing ratio of the magnetic powder and the binder so as to have the optimal magnetism and insulation property.

In this case, the magnetic layer 100 has the first coil 210 to be described below formed on one surface thereof, that is, a top surface thereof as shown in FIG. 1, and therefore, the magnetic layer needs to have the sufficient insulation property so that an upper layer portion 101 including the top surface thereof is insulated between the lines of the first coil 210. Therefore, the magnetic layer 100 may be formed so that the upper layer portion 101 have the relative mixing ratio of the binder to the magnetic power higher than that of the lower layer portion 102. In this case, the magnetic layer 100 has the lower relative mixing ratio of the magnetic powder to the binder at the upper layer portion 101 and therefore, may be formed to have the higher relative mixing ratio of the magnetic powder to the binder at the lower layer portion 102. As a result, the magnetic layer 100 may generally have sufficient magnetism.

The first coil 210 is formed on one surface of the magnetism layer 100. In this case, the first coil 210 may have a loop form having a length direction in a first axis direction, for example, an X-axis direction as shown in FIG. 2. In addition, the first coil 210 may be formed in plural so as to be connected in parallel, while being arranged in a second axis direction, for example, a Y-axis direction as shown in FIG. 2.

The insulating layer 150 serves to electrically insulate the first coil 210 and the second coil 220 to be described below. Further, the insulating layer 150 insulates between the neighboring lines of the first coil 210, together with the magnetic layer 100. In addition, the insulating layer 150 also serves to insulate the neighboring lines of the second coil 220 to be described below. Therefore, the insulating layer 150 may be formed of materials having electric insulation property. For example, the insulating layer 150 may be formed of various insulating materials such as polyethyleneterephthalate (PET), polycarbonate (PC), polymethylmethacrylate (PMMA), polyethylenenaphthalate (PEN), polyethersulfone (PES), and the like. In addition, as the insulating layer 150, an optically clear adhesive (OCA) may also be used.

The insulating layer 150 is formed on one surface of the magnetism layer 100. In this case, the insulating layer 150 is formed to cover the first coil 210. In this case, the first coil 210 is formed to be buried between the magnetic layer 100 and the insulating layer 150 as shown in FIG. 1 and the magnetic layer 100 and the insulating layer 150 may sufficiently insulate between the neighboring lines of the first coil 210.

The second coil 220 is formed on one surface of the insulating layer 150. As shown in FIG. 2, the second coil 220 may have a loop form having a length direction in a direction intersecting the first coil 210. In this case, the second coil 220 may have a length direction in the second axis direction, that is, the Y-axis direction, vertical to the first axis direction so as to vertically intersect the first coil 210. In addition, the second coil 220 may be formed in plural so as to be connected with in parallel while being arranged in the X-axis direction.

Meanwhile, the foregoing first coil 210 and second coil 220 are configured to sense the touched location of the input device.

First, the input device (not shown) such as an electronic pen may include a resonance circuit including an inductor and a capacitor. In the input device, the resonance circuit is resonated by electromagnetic force input from the outside. The resonance circuit generates induced current while being resonated and energy generated by the generated induced current may be stored in the capacitor.

Further, when the supply of electromagnetic force stops from the outside, the input device discharges the electromagnetic force while the capacitor is resonated with the inductor by the energy stored in the capacitor.

The electromagnetic force discharged from the input device generates a voltage difference between the first coil 210 and the second coil 220. The controller (not shown) detects the touched location of the input device by confirming the voltage difference.

Any one of the first coil 210 and the second coil 220 may be used as a driving coil supplied with current from the controller. In addition, the other one thereof may be used as a sensing coil that generates voltage based on a magnetic line of force induced from the driving coil. The voltage (induced electromotive force) induced from the sensing coil is proportional to variation of time of the magnetic line of force induced from the driving coil. Therefore, in order to induce voltage from the sensing coil, the magnetic line of force induced from the driving coil needs to be periodically changed. Consequently, the driving coil may be supplied with alternating current (AC) from the controller so as to periodically change the induced magnetic line of force.

The first coil 210 and the second coil 220 have voltage while being controlled by the controller. In this case, when the input device approaches the first and second coils 210 and 220, the voltage difference is generated while the first and second coils 210 and 220 being affected by the electromagnetic force discharged from the input device as described above and the controller recognizes the voltage difference to confirm the touched location of the input device.

Meanwhile, the preferred embodiment of the present invention may further include a power coil 230. Prior to the detailed description of the power coil 230, the input device may be first configured as a powerless input device resonated by receiving the electromagnetic force from the outside as described above, but may also be formed to have a structure in which the resonance circuit of the input device is resonated by receiving AC power from the outside. When the input device is operated by receiving the AC power from the outside, the sensor for a digitizer may not further include a separate power coil 230. However, when the input device, which is the powerless input device as described above, is supplied with the electromagnetic force by the sensor for a digitizer, the sensor for a digitizer may further include the separate power coil 230.

In the sensor for a digitizer, any one of the first coil 210 and the second coil 220 may perform a function of the power coil 230. However, the sensor for a digitizer further includes the separate power coil 230 that is separately controlled by the controller, thereby making it possible to more improve the reliability of the signal transmitted and received between the input device and the coil.

The sensor 1 for a digitizer according to the preferred embodiment of the present invention may further include the power coil 230. The power coil 230 may be formed on one surface of the insulating layer 150, together with the second coil 220. In this case, the power coil 230 may have a loop form formed along the outer side of the insulating layer 150 so that the power coil 230 and the second coil 220 do not intersect each other.

The sensor 1 for a digitizer configured as described above may be coupled with an image display 300 and a window 400 that are disposed in one direction as shown in FIG. 1.

Meanwhile, a method for manufacturing the sensor 1 for a digitizer according to a preferred embodiment of the present invention will be described below. However, the overlapping portions as the foregoing contents will be omitted in the following description.

As shown in FIGS. 3 to 7, the method for manufacturing the sensor 1 for a digitizer includes (a) forming the magnetic layer 100 on one surface of the base film 10, (b) forming the first coil 210 on one surface of the magnetic layer 100, (c) forming the insulating layer 150 on one surface of the magnetic layer 100 so as to cover the first coil 210, and (d) forming the second coil 220 on one surface of the insulating layer 150.

In the step (a), as shown in FIG. 3, the magnetic layer 100 is formed on one surface of the base film 10. As an example of the base film 10, a PET film, and the like, may be used.

The magnetic layer 100 may be formed by applying the mixture of the magnetic powder and the binder to one surface of the base film 10 and thermo-compressing the mixture by a rolling method, a casting method, and the like. However, as a method for forming the magnetic layer 100 on the base film 10, various known methods in addition to the foregoing methods may be also used.

In this case, the above mixture may also be formed of a first mixture and a second mixture. In detail, the first mixture may have the higher relative mixing ratio of the magnetic powder to the binder and the second mixture may have the higher relative mixing ratio of the binder to the magnetic powder, unlike the first mixture. In this case, when comparing the first mixture with the second mixture, the second mixture has the relative mixing ratio of the magnetic powder to the binder higher than that of the first mixture. The first mixture and the second mixture may be sequentially applied to the base film 10. That is, the first mixture is first applied to the base film 10 and then, the second mixture may be applied to the layer to which the first mixture is applied, while being stacked thereon. Next, the magnetic layer 100 may be formed by curing the first mixture and the second mixture as described above. The magnetic layer 100 formed as described above is formed so that the second mixture layer that is the upper layer portion 101 has the mixture ratio of the binder to the magnetic powder higher than that of the first mixture layer that is the lower layer 102 and has insulation property enough to insulate between the neighboring lines of the first coil 210 formed on the magnetic layer 100.

In the step (b), the first coil 210 is formed on one surface of the magnetic layer 100 as shown in FIG. 4. The first coil 210 may be formed on the magnetic layer 100 by various methods such as plating, deposition, and the like. Further, the first coil 210 may have a loop form. In addition, the plurality of first coils 210 may also be arranged in parallel so as to have a structure in which they are connected in parallel.

In the step (c), the insulating layer 150 is formed on one surface of the magnetic layer 100 as shown in FIG. 5.

The insulating layer 150 may be formed of various materials having insulation property such as PET, and the like. The insulating layer 150 is applied to one surface of the magnetic layer 100 so as to cover the first coil 210. Therefore, the first coil 210 is fully buried in the insulating layer 150 and the magnetic layer 100 and therefore, may sufficiently insulate between the neighboring lines of the first coil 210.

In the step (d), the second coil 220 is formed on one surface of the insulating layer 150 as shown in FIG. 6.

The second coil 220 may be formed on the magnetic layer 150 by various methods such as plating, deposition, and the like, like the first coil 210. The second coil 220 may have a loop form, like the first coil 210. In this case, the second coil 220 may be formed to have a length direction in a direction intersecting the first coil 210. Further, the plurality of second coils 220 may be arranged in parallel so as to have a structure in which they are connected in parallel.

Further, the preferred embodiment of the present invention may further include forming the power coil 230 after the step (d) as shown in FIG. 7. As described above, the power coil 230 may have a loop form formed along the outer side of the insulating layer 150. As the forming method thereof, the same method as the method for forming the first coil 210 or the second coil 220 may be used.

Meanwhile, the base film 10 prepared in the step (a) may be removed by being peeled off after the step (a). FIG. 1 shows a state in which the base film 10 is removed. The base film 10 may be peeled off immediately after the step (a) and may also be peeled off after any of the steps (b) to (d).

According to the preferred embodiments of the present invention, the coil is disposed on the magnetic layer, thereby making it possible to improve the stability of a signal transmitted and received from and to the coil.

In addition, the coil is not formed on the separate substrate but is directly formed on the magnetic layer to simplify the structure, thereby making it possible to improve the manufacturing convenience and save the manufacturing costs.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A sensor for a digitizer, comprising:
a magnetic layer having insulation property;
a first coil formed on one surface of the magnetic layer;
an insulating layer formed on one surface of the magnetic layer while covering the first coil; and
a second coil formed on one surface of the insulating layer.

2. The sensor for a digitizer as set forth in claim 1, further comprising:
a power coil formed on one surface of the insulating layer.

3. The sensor for a digitizer as set forth in claim 2, wherein the power coil is formed on an outer side of the insulating layer.

4. The sensor for a digitizer as set forth in claim 1, wherein the magnetic layer is formed by curing a mixture of a magnetic powder and a binder.

5. The sensor for a digitizer as set forth in claim 4, wherein the magnetic powder includes an alloy powder of Fe—Si—Al.

6. The sensor for a digitizer as set forth in claim 4, wherein the binder includes acrylonitrile-butadience-styrene (ABS).

7. The sensor for a digitizer as set forth in claim 4, wherein an upper layer portion of the magnetic layer has the mixture ratio of the binder relatively higher than that of a lower layer portion of the magnetic layer.

8. A method for manufacturing a sensor for a digitizer, comprising:
(a) forming a magnetic layer on one surface of a base film;
(b) forming a first coil on one surface of the magnetic layer;
(c) forming an insulating layer on one surface of the magnetic layer so as to cover the first coil; and
(d) forming a second coil on one surface of the insulating layer.

9. The method as set forth in claim 8, further comprising:
after the step (a), peeling off the base film from the magnetic layer.

10. The method as set forth in claim 8, further comprising:
after the step (d), forming a power coil on one surface of the insulating layer.

11. The method as set forth in claim 10, wherein the power coil is formed on an outer side of the insulating layer.

12. The method as set forth in claim 8, wherein in the step (a), the magnetic layer is formed by applying and curing a mixture of a magnetic powder and a binder to the base film.

13. The method as set forth in claim 12, wherein the magnetic powder includes an alloy powder of Fe—Si—Al.

14. The method as set forth in claim 12, wherein the binder includes acrylonitrile-butadience-styrene (ABS).

15. The method as set forth in claim 12, wherein in the step (a), the magnetic layer is formed by sequentially applying and curing a first mixture and a second mixture in which the magnetic powder and the binder are mixed to the base film, the second mixture having a mixing ratio of the binder relatively higher than that of the first mixture.
